(19) United States
(12) Patent Application Publication
(10) Pub. No.: US 2011/0157636 A1
(43) Pub. Date: Jun. 30, 2011

(54) PRINTING APPARATUS, METHOD FOR CONTROLLING PRINTING APPARATUS, AND STORAGE MEDIUM

(75) Inventor: Ryo Maeda, Yokohama-shi (JP)

(73) Assignee: CANON KABUSHIKI KAISHA, Tokyo (JP)

(21) Appl. No.: 12/967,660

(22) Filed: Dec. 14, 2010

(30) Foreign Application Priority Data
Dec. 26, 2009 (JP) 2009-296508

(51) Int. Cl. G06F 3/12

(52) U.S. Cl. 358/1.15

(57) ABSTRACT

A control method for controlling a printing apparatus for printing an image according to image data includes displaying an image, specifying a type of a gesture according to a locus of coordinate information input by a user via an operation unit, detecting an area where the gesture is made, and performing print setting for printing image data according to the specified type of the gesture and the detected area.

### BACKGROUND OF THE INVENTION

1. Field of the Invention

The present invention relates to a printing apparatus, a method for controlling the printing apparatus, and a storage medium.

2. Description of the Related Art

Conventionally, an image processing apparatus, such as a printing apparatus or a multifunction peripheral, receives print setting from a user via a hard key and then performs printing according to the received print setting when a printing instruction is given.

Further, a display unit of the image processing apparatus typically includes a touch panel, and a user performs print setting through pressing of a button of the display unit by finger contact or the like with the button.

However, since the display unit of the image processing apparatus usually is small in display area, the conventional method for specifying the print setting using the button requires passing through several screens. Thus, an operation for performing the print setting is likely to become complicated.

As a method for checking a printing result based on the print setting set by the user, besides a method for checking what is printed out on a sheet of paper, there is a method for using an image processing apparatus having a function of allowing a user to check the printing result through a preview of the printing result on a display unit. However, when displaying the preview, the user has to perform an operation of displaying a preview screen on the display unit, which is an operation different from that of displaying a print setting screen.

For this reason, as a method for operating the image processing apparatus, there has been a demand for performing the print setting in a more intuitive way. To this end, a print setting method using a gesture has been discussed. A gesture means a movement made with part of a body, especially hands, to express something to other people. However, the locus generated by the user on the touch panel is herein referred to as a gesture.

For example, in an image processing apparatus discussed in Japanese Patent Application Laid-Open No. 2006-99389, a gesture is associated in one-to-one correspondence with print setting. For example, when “Z” is drawn with a gesture, “2in1” is set. As another example, when “L” is drawn with a gesture, an instruction to “orient an image in landscape” can be generated.

However, in the case of the conventional print setting method using a gesture, the image processing apparatus detects the locus of the gesture and performs the setting corresponding to the gesture, but it does not consider the position of the gesture.

For this reason, when a plurality of stapling positions exists, the user can instruct the stapling by the gesture, but it is difficult to designate a position of the paper to be stapled.

For example, if different gestures are made according to stapling positions, the number of gestures increases, and the user has to memorize many gestures.

### SUMMARY OF THE INVENTION

According to an aspect of the present invention, a printing apparatus for printing an image according to image data includes a display unit configured to display an image, a specifying unit configured to specify a type of a gesture according to a locus of coordinate information input by a user via an operation unit, a detecting unit configured to detect an area where the gesture is made, and a setting unit configured to perform print setting for printing image data according to the type of the gesture specified by the specifying unit and the area detected by the detecting unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image processing apparatus according to an exemplary embodiment of the present invention.

FIG. 2 is a view illustrating a user interface (UI) displayed on a display device.

FIG. 3 is a view illustrating a print setting table stored in a hard disk drive (HDD).

FIGS. 4A to 4D are views illustrating transition states of a UI displayed on the display device.

FIG. 5 is a flowchart illustrating a control procedure in the image processing apparatus.

FIG. 6 is a flowchart illustrating a control procedure in the image processing apparatus.

FIG. 7 is a view illustrating a UI displayed on the display device.

### DESCRIPTION OF THE EMBODIMENTS

Various exemplary embodiments, features, and aspects of the invention will be described in detail below with reference to the drawings.

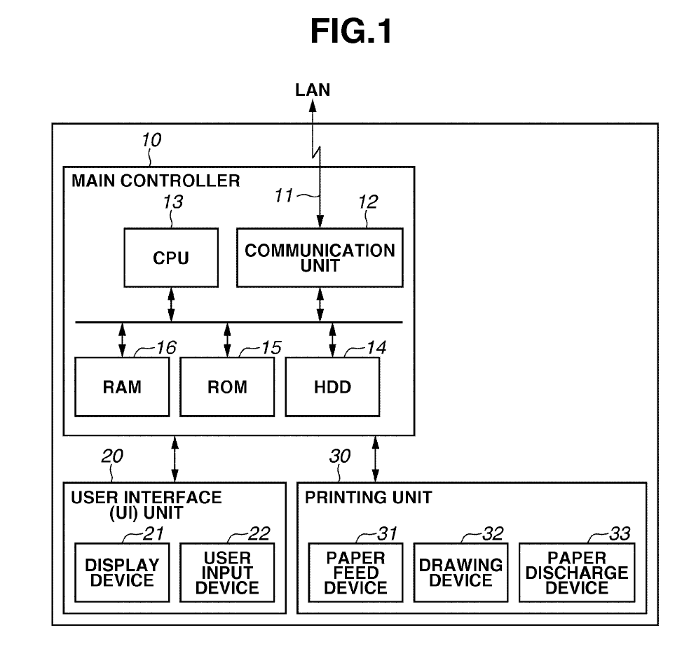

FIG. 1 is a block diagram illustrating a configuration of an image processing apparatus according to an exemplary embodiment of the present invention. The image processing apparatus includes a main controller 10, a user interface (UI) unit 20, and a printing unit 30.

Referring to FIG. 1, the main controller 10 mainly includes a local area network (LAN) 11, a communication unit 12, a central processing unit (CPU) 13, a hard disk drive (HDD) 14, a read-only memory (ROM) 15, and a random access memory (RAM) 16. The LAN 11 represents a path for exchanging data with an external apparatus. The communication unit 12 is connected with a network via the LAN 11.

When receiving a printing request from a computer device connected to the LAN 11, the main controller 10 renders print data into image data by using the RAM 16. The print data is transmitted from a printer driver installed on the computer device. For example, as the print data, PDL data that complies with a page description language may be used.

The CPU 13 controls the whole operation of the image processing apparatus, that is, controls the image processing apparatus in general by loading a program stored in the ROM 15 or the HDD 14 to the RAM 16 and executing the program.

The HDD 14 functions as a storage for storing document data or setting data and is also used for a BOX function for storing user information. The HDD 14 may be configured by using a flash memory as the storage.

The ROM 15 functions as a boot ROM and stores a system boot program. The CPU 13 operates based on a program read via the ROM 15. The RAM 16 is a system work memory for operation of the CPU 13.

The UI unit 20 includes a display device (a display unit) 21 and a user input device (an operation unit) 22. The display device 21 displays a status of each unit and a user interface for image processing setting. The user input device 22 receives an input from the user via the touch panel and notifies the CPU 13 of the received content. The user input device 22 may include a hard key for receiving an operation from the user.

Thus, the CPU 13 recognizes the gesture by detecting that the user input device 22 is pressed down and detecting the locus of the position pressed by the user (the locus of the finger) . The display device 21 and the user input device 22 may be integrally configured.

The printing unit 30 includes a paper feed device 31, a drawing device 32, and a paper discharge device 33. The paper feed device 31 is called a cassette or a deck and retains sheets of printing paper. When a printing request is received from the main controller 10, the paper feed device 31 feeds the printing paper to the drawing device 32.

The drawing device 32 draws an image on the paper received from the paper feed device 31 and then sends the paper to the paper discharge device 33. In a drawing process, in response to a printing process through an electrophotographic process or an ink jet, an image forming process is executed by a color image, a monochrome image, or a combination thereof, and an image is printed on the fed printing paper based on print data.

The paper discharge device 33 receives the paper from the drawing device 32 and performs a finishing process, such as punching or stapling, before discharging the paper. Optionally, the paper discharge device may be detachably attached to the image processing apparatus and execute a sheet process depending on the type of the paper discharge device. For example, the user can appropriately replace and mount a paper discharge device having a stapling function for binding sheets of recording paper by stapling and a folding function for folding sheets of recording paper or a paper discharge device having a punching function for performing punching.

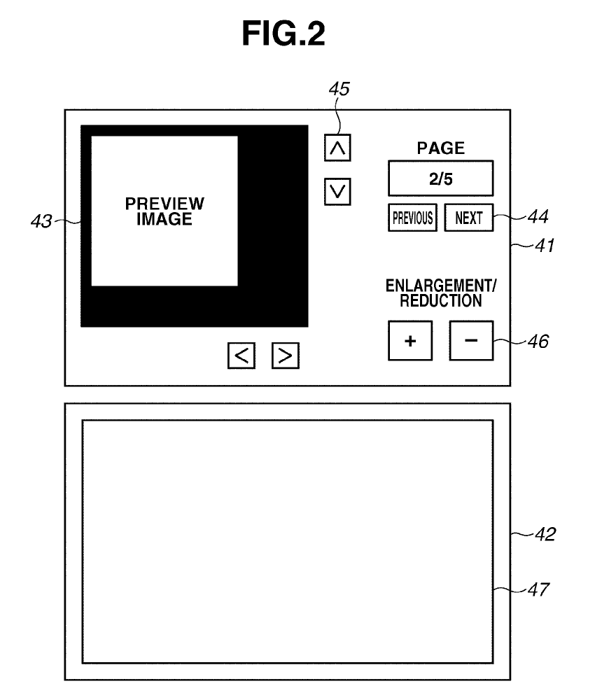

FIG. 2 is a view illustrating an example of a user interface displayed on the display device 21 illustrated in FIG. 1. A preview screen 41 and a gesture screen 42 will be described below.

Referring to FIG. 2, the preview screen 41 displays a preview image on the display device 21. The gesture screen 42 receives a gesture from the user via the user input device 22 and displays the gesture.

The preview screen 41 includes a preview display area 43, a page switch button 44, a scroll button 45, and an enlargement/reduction button 46.

The preview display area 43 represents a screen area for displaying the preview image. A display range of the preview image is changed by pressing the scroll button 45 or the enlargement/reduction button 46.

The page switch button 44 switches a page for preview when a file for performing preview has multiple pages. The scroll button 45 is used when the whole preview image cannot be displayed since the preview image is enlarged and can change a display portion of the preview image.

The enlargement/reduction button 46 can change a display magnification ratio of the preview image. When the magnification ratio is 100%, the whole image is displayed on the preview image area 43. For example, when the magnification ratio of the image is changed to 200%, 400%, or 800%, one half of the image is displayed in the case of 200%, one fourth of the image is displayed in the case of 400%, and one eighth of the image is displayed in the case of 800%.

The gesture screen 42 includes a gesture input area 47 for receiving coordinate information corresponding to a cursor manipulated by the user. When the finger of the user that is pressing the gesture input area 47 moves, the gesture input area 47 stores the locus and the position of the finger in the RAM 16. As a result, the gesture of the user is received, and the CPU 13 can analyze coordinate information corresponding to the obtained locus with reference to a print setting table 60, which will be described below, to thereby specify the gesture.

Specifically, the gesture input area 47 can obtain coordinate information of the position pressed by the user. The CPU 13 obtains coordinates of the cursor on the gesture input area 47 at a constant interval and thus stores discrete coordinate information in the RAM 16 when the position pressed by the user changes.

Thereafter, the CPU 13 converts the discrete coordinate information stored in the RAM 16 to a vector within a certain time period and recognizes the locus of the coordinate information corresponding to the position pressed by the user as the gesture. The CPU 13 of the main controller 10 analyzes the locus and the position stored by the gesture input area 47 and determines whether the locus and the position agree with a predetermined gesture by referring to the print setting table 60 used for analyzing the registered gesture.

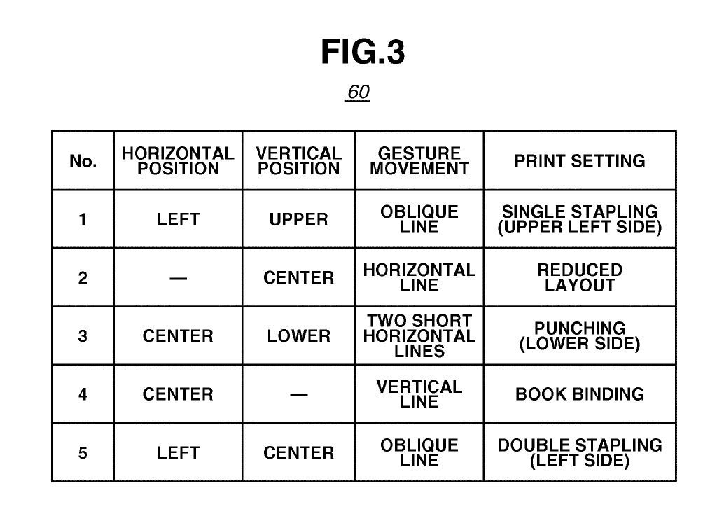

The flow of performing the print setting via the gesture input of the user will be described below. FIG. 3 is a view illustrating an example of the print setting table 60 stored in the HDD 14 illustrated in FIG. 1. In the present exemplary embodiment, the HDD 14 stores print setting information, in which positions (a vertical position and a horizontal position) specified by the coordinate information of the cursor on the gesture input area 47 manipulated by the user are associated with a specific gesture, as the print setting table 60.

The present exemplary embodiment is described in connection with an example of a single gesture, but a combination of a gesture of reduced layout illustrated in FIG. 3 and any other gesture can be received as the print setting to the extent that the print setting is executable by the image processing apparatus. In this case, control of displaying an error input of the gesture from the user by referring to a table indicating the print setting that cannot be set at the same time may be performed.

Further, a print setting that is not illustrated in FIG. 3, such as two-sided printing, can be set by associating the gesture with the positions of the gesture (the vertical position and the horizontal position) . The two-sided printing can be set even via a combination with any other gesture.

The present exemplary embodiment is described in connection with an example in which the gesture is a simple straight line motion, but a curved line gesture or a gesture in which a straight line and a curved line are combined may be used.

Further, for each of the users, a print setting table in which the gesture is associated with the print setting may be stored in the HDD 14, and the print setting may be performed by the gesture corresponding to the authorized user. Associating between the gesture and the print setting in the print setting table managed for each of the users may be changed by the authorized user. Referring to FIG. 3, the print setting table 60 stores information of the horizontal position and the vertical position for specifying the position of the gesture, the gesture (the locus of the input coordinates), and the print setting in the HDD 14 in the correspondence relationship. The horizontal position is referred to as the position of the display device in the horizontal direction when the upper and lower sides of the display screen of the display device are aligned in the vertical direction. The vertical position is referred to the position in the vertical direction of the display screen of the display device. The print setting table 60 functions as a table used to determine which print setting is associated with a combination of the horizontal position, the vertical position, and the gesture.

For example, in an example of No. 1, the horizontal position corresponds to “the left,” the vertical position corresponds to “the upper,” and the gesture corresponds to “the oblique line,” and the print setting is “single stapling (the upper left side).” Further, in an example of No. 5, the horizontal position corresponds to “the left,” the vertical position corresponds to “the center,” and the gesture corresponds to the “oblique line,” and the print setting is “double stapling (the left side).” Here, the “oblique line” of No. 1 and the “oblique line” of No. 5 are the same gesture and are oblique lines that lead from an upper-right point in an image to a lower-left point. The length of the oblique line may be either long or short. The example of No. 5 is the same in gesture as the example of No. 1 but has different print setting since the position is different. In the present exemplary embodiment, there is described an example in which the gesture input area 47 is divided into 9 areas, 3×3 areas, and the 9 areas include “the upper left,” “the upper,” “the upper right,” “the left,” “the center,” “the right,” “the lower left,” “the lower,” and “the lower right.”

When a predetermined gesture is received from the user, the CPU 13 of the main controller 10 refers to the print setting table 60 stored in the HDD 14. The CPU 13 retrieves the print setting associated with the received gesture from the print setting table 60.

The CPU 13 determines whether the print setting based on the gesture obtained via the RAM 16 is print setting executable by a finisher option mounted in the paper discharge device 33. For example, there is a case in which specific post processing cannot be executed depending on the type of the paper discharge device 33. For example, there is a case in which the punching function can be executed, but the stapling function cannot be executed. On the other hand, there is a case in which the stapling function can be executed, but the punching function cannot be executed.

Further, there is a case in which the stapling function can be executed, but the stapling position of the recording paper is restricted due to the configuration of the stapler. For example, stapling (the upper left side) can be executed, but stapling (the left side) cannot be executed. The paper discharge device 33 is detachably attached to the image processing apparatus and is configured so that the user can replace the paper discharge device 33 appropriately depending on the use environment.

When the paper discharge device 33 is attached to the image processing apparatus, the CPU 13 obtains capability information representing a type of post processing executable by the paper discharge device 33 and stores the capability information in the HDD 14.

The CPU 13 determines whether the print setting received from the user is executable based on the capability information stored in the HDD 14. When it is determined that the print setting received from the user is executable, the CPU 13 fixes the print setting as setting used for processing of image data and executes processing for reflecting the print setting in the preview screen 41.

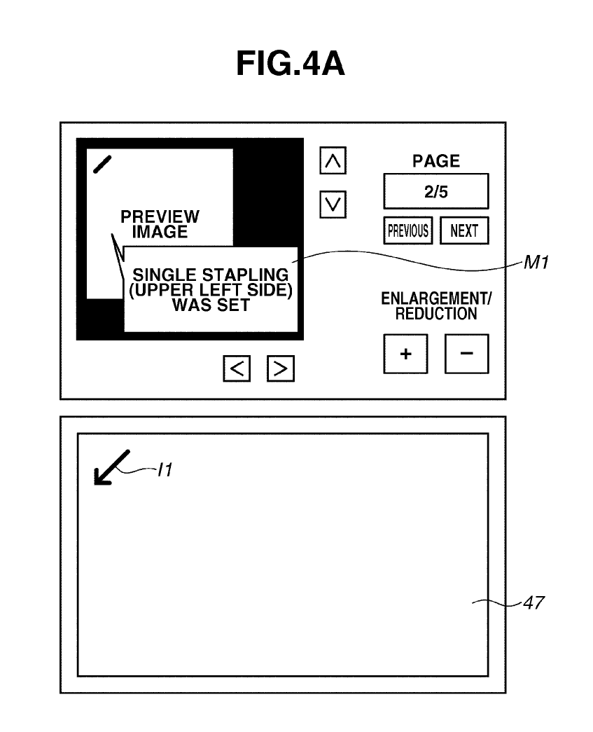

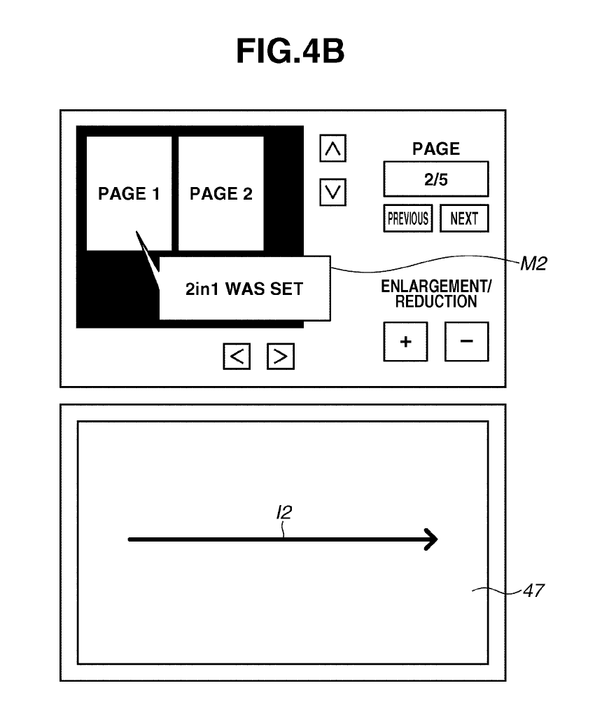

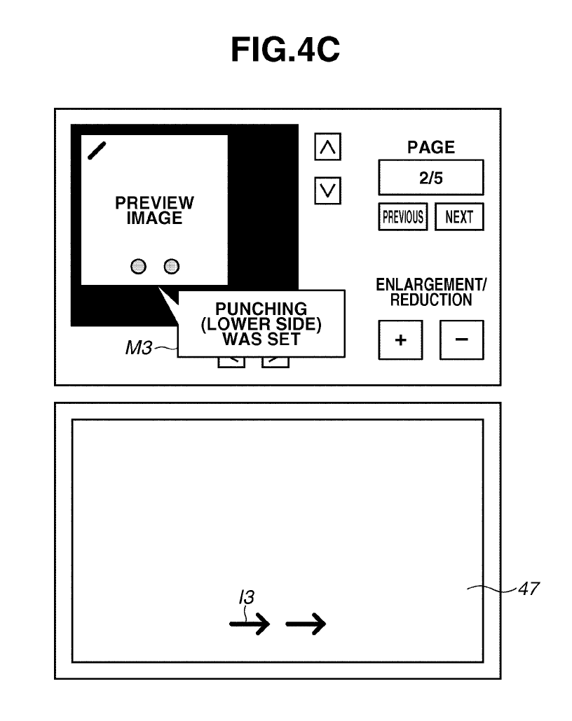

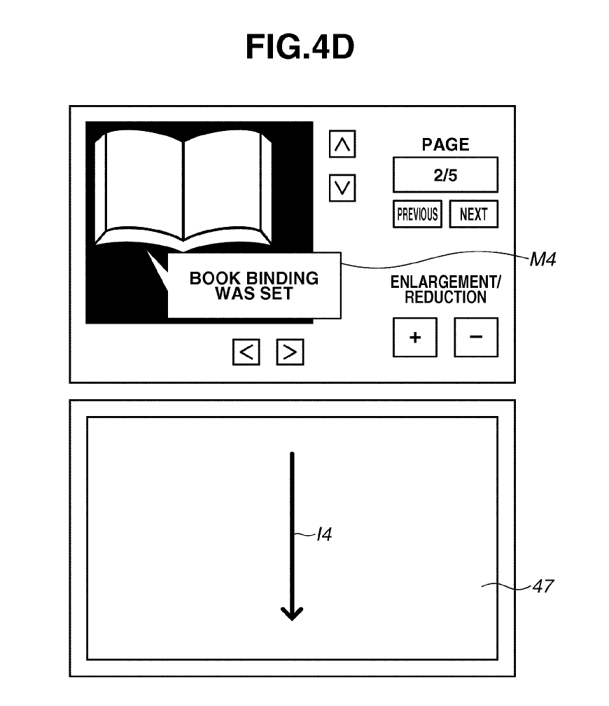

A relationship between four gestures as specific examples and print setting will be described below with reference to FIGS. 4A to 4D.

FIGS. 4A to 4D are views illustrating transition states of the user interface displayed on the display device 21 illustrated in FIG. 1.

FIG. 4A illustrates a case in which the user inputs the gesture of the oblique line (the oblique line) at the upper left side of the gesture input area 47 by the finger in the gesture screen 42. The upper left side is a position corresponding to the upper left side when the gesture input area 47 is divided into 9 areas and also corresponds to an upper left coordinate area of the display area of the gesture screen 42 when viewed from the user. That is, the CPU 13 detects the position (the area) where the user have gestured as the upper left. The CPU 13 detects the movement locus of the position detected on the gesture screen 42 as the “oblique line.” The CPU 13 reads the coordinate information of the position manipulated by the user at a predetermined time interval and receives a locus I1 of the coordinate information input by the user (a leading end of the arrow corresponds to an end point coordinate position) as the gesture for print setting.

As a result, the CPU 13 receives the gesture that the user inputs to the gesture screen 42 with the finger. The CPU 13, which has received the gesture, determines that the gesture input by the user requires “single stapling (the upper left side)” with reference to the print setting table 60. Based on the determination result, the CPU 13 displays a dialogue M1 “single stapling (upper left side) was set” on the preview screen 41.

The CPU 13 displays an icon indicating single stapling (upper left side) on the preview display area 43 as specified print setting. Through the position of the gesture input from the gesture screen 42 of the display device 21, the gesture, and the content of the specified print setting, the user can visually check that the setting of stapling at the upper left side has been received.

FIG. 4B illustrates an example in which a gesture of a horizontal line is being input to the center of the gesture input area 47. In response to the gesture input from the user, the CPU 13 refers to the print setting table 60 and determines the content of print setting. The CPU 13 reads coordinate information at a predetermined time interval and receives a locus I2 of the coordinate information input from the user (a leading end of the arrow corresponds to an endpoint coordinate position) as the gesture for print setting.

In this example, the CPU 13 determines that the gesture indicates a “reduced layout” and displays a dialogue “2in1 was set” as specified print setting on the preview screen 41. The CPU 13 displays the first page and the second page for indicating 2in1 on the preview display area 43 side-by-side.

As a result, through the position of the gesture input from the gesture screen 42 of the display device 21, the gesture, and the content of the specified print setting, the user can visually check that the setting of the reduced layout has been received.

FIG. 4C illustrates an example in which the user manipulates the cursor to input a gesture for drawing two horizontal lines in a lower portion of the gesture input area 47 in the gesture screen 42. In response to the gesture input from the user, the CPU 13 refers to the print setting table 60 and determines the content of print setting. The CPU 13 reads coordinate information of the cursor manipulated by the user at a predetermined time interval and receives a locus I3 of the coordinate information input from the user (a leading end of the arrow corresponds to an end point coordinate position) as the gesture for print setting.

In this example, the CPU 13 determines that the gesture indicates “punching (lower side)” and displays a dialogue “punching (lower side) was set” on the preview screen 41. The CPU 13 displays an icon indicating punching on the preview display area 43 as the print setting corresponding to the gesture.

As a result, through the position of the gesture input from the gesture screen 42 of the display device 21, the gesture, and the content of the specified print setting, the user can visually check that setting of punching (lower side) has been received.

FIG. 4D illustrates an example in which the user manipulates the cursor to input a gesture for drawing a vertical line at the center of the gesture input area 47 in the gesture screen 42. The CPU 13 reads coordinate information of the cursor manipulated by the user at a predetermined time interval and receives a locus 14 of the coordinate information input from the user (a leading end of the arrow corresponds to an end point coordinate position) as the gesture for print setting. In response to the gesture input from the user, the CPU 13 refers to the print setting table 60 and determines the content of print setting.

In this example, the CPU 13 determines that the gesture indicates “book binding” and displays a dialogue “book binding was set.” The CPU 13 displays an image of a book form for indicating book binding on the preview display area 43 as specified print setting.

As a result, through the position of the gesture input from the gesture screen 42 of the display device 21, the locus of the gesture, and the print setting table 60, the user can visually check that setting of book binding has been received.

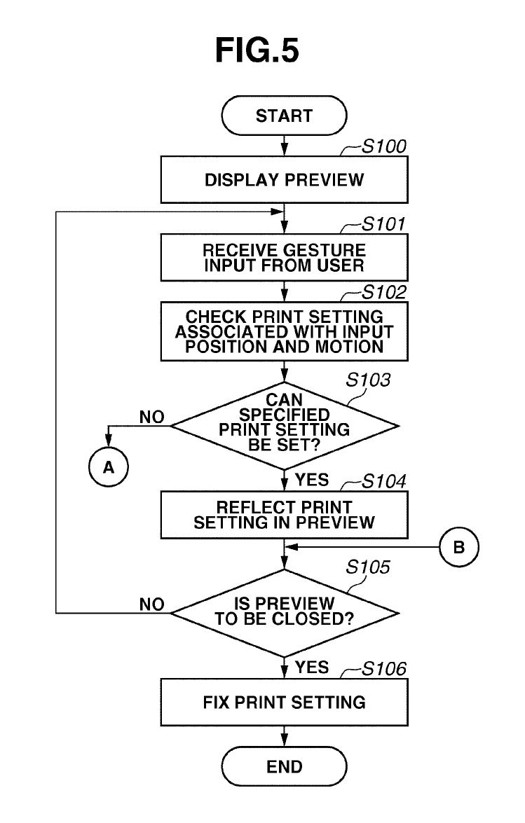

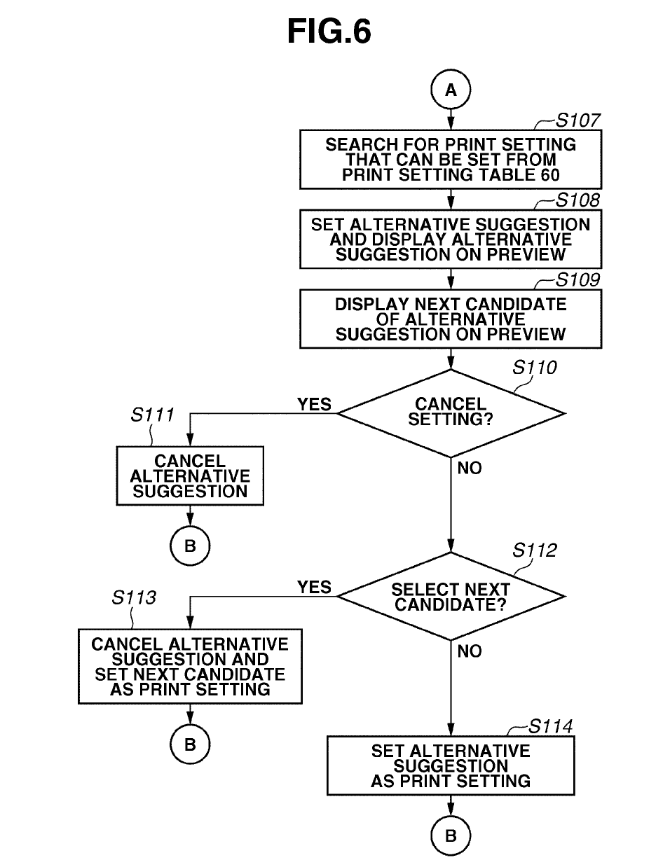

FIGS. 5 and 6 are flowcharts illustrating an example of a control procedure in the image processing apparatus according to the present exemplary embodiment. The present example is an example of a print setting process executed by the CPU 13 of the main controller 10. Steps S100 to S114 are implemented by the CPU 13 loading a control program stored in the HDD 14 or the ROM 15 and executing the control program.

After electric power is supplied, in step S100, the CPU 13 displays a preview image on the preview display area 43. In step S101, the gesture input area 47 receives an input based on the gesture by the user. When the CPU 13 detects that coordinate information input to the RAM 16 has been obtained, the CPU 13 stores the locus of the input coordinate information and the position, on the gesture input area 47, where the gesture is made. In step S102, the CPU 13 compares the position and the locus of the gesture with the print setting table 60 to check the content of the print setting received from the user. As a result, the CPU 13 can specify the print setting received from the user.

In step S103, the CPU 13 determines whether the corresponding print setting exists, and while checking capability information of the paper discharge device 30 stored in the HDD 14, determines whether the print setting specified as the print setting received from the user is executable. If it is determined that the corresponding print setting does not exist in the print setting table 60, thus, if the gesture is not recognized, the CPU 13 displays an error message on the display device 21. If it is determined that the print setting can be set (YES in step S103), then in step S104, the CPU 13 displays a preview based on the print setting result on the preview screen 41.

In step S105, the CPU 13 determines whether the user inputs an instruction to close the preview screen 41. If the CPU 13 determines that the user inputs the instruction to close the preview screen 41 (YES in step S105), then in step S106, the CPU 13 finally fixes the print setting set by the gesture and ends the present process.

On the other hand, if it is determined in step S103 that the print setting cannot be set (NO in step S103), then the processing proceeds to step S107 illustrated in FIG. 6. Since stapling at the right side is input as the gesture as an example in which it is determined that it cannot be set, a case of suggesting the stapling at the upper left side to the user as executable print setting is assumed. In this case, an example in which the CPU 13 sets stapling (upper left side) as the print setting that can be set, that is, an alternative print setting candidate, is described below.

First, in step S107, the CPU 13 searches for an alternative setting for the input print setting from among the registered print settings by referring to an alternative table (not illustrated). Next, in step S108, the CPU 13 suggests a first alternative candidate to the user on the preview screen 41 as a candidate of print setting that will replace the corresponding print setting. Here, the alternative settings corresponding to respective settings are stored. For example, as an alternative setting of setting “stapling the right side,” “punching the left side” and “stapling the upper left side” are stored in the associating relationship. When setting “stapling the right side” is received, setting of punching the left side and setting of stapling the upper left side are simultaneously suggested to the user. Alternately, when a plurality of alternative settings exists, a priority order is given to each of a plurality of alternative settings, and the alternative settings are suggested to the user in order of higher priority.

For example, since the print setting (stapling the left side) unintended by the user may be suggested as an alternative setting, then in step S109, the CPU 13 displays a next candidate (punching the left side) of print setting suggested as an alternative on the preview screen 41.

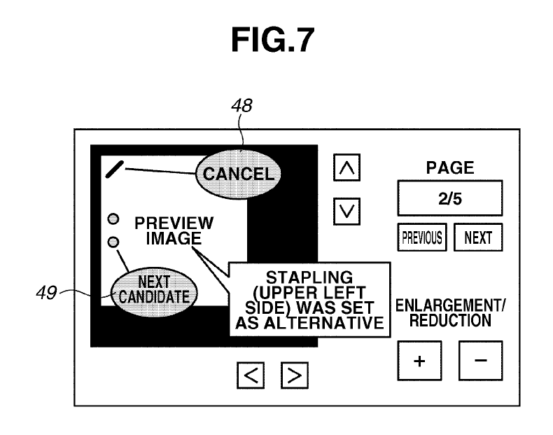

FIG. 7 is a view illustrating an example of a user interface displayed on the display device 21 illustrated in FIG. 1. In this example, a candidate of print setting alternative to the specified print setting is suggested and displayed on the display device 21 according to the flow of FIG. 6 executed by the CPU 13.

Referring to FIG. 7, a cancel button 48 functions as a button for canceling a plurality of print setting candidates, such as stapling and punching, displayed at the same time. A next candidate button 49 functions to fix a next candidate of print setting suggested as an alternative.

For example, if the CPU 13 determines that stapling (right side) has been input as the gesture of the user but the paper discharge device 33 cannot perform stapling (right side) due to the configuration of the paper discharge device 33, stapling (upper left side) is suggested as a candidate of print setting as an alternative.

When stapling (upper left side) suggested to the user as an alternative setting and punching as the next candidate are not the desired print setting, the user can simultaneously cancel a plurality of alternative candidates by pressing the cancel button 48. In this case, the alternative settings displayed on the display device 21 disappear. In the screen illustrated in FIG. 7, the CPU 13 suggests the next candidate to the user at the same time. Thus, if the CPU 13 determines that stapling at the left side cannot be performed but punching at the left side can be performed, punching (left side) is suggested as a next candidate as an alternative suggestion.

When the suggestion of the next candidate by the CPU 13 is a desired print setting, the user presses the next candidate button 49 to set print setting of the next candidate. The next candidate button 49 functions as a button for selecting one of a plurality of print setting candidates simultaneously displayed, for example, selecting punching from stapling and punching, as a next candidate.

Next, in step S110, the CPU 13 determines whether the user inputs a request for canceling the displayed setting, that is, whether the cancel button 48 is pressed. When the CPU 13 determines that setting cancellation of the alternative suggestion has been received (YES in step S110), then in step S111, the print setting corresponding to the displayed alternative suggestion is canceled, that is, the input of the gesture by the user is canceled, and the processing returns to step S105.

On the other hand, if the CPU 13 determines that the cancel button 48 is not pressed (NO in step S110), then in step S112, the CPU 13 determines whether the user inputs selection of the next candidate, that is, whether the next candidate button 49 is pressed. If the CPU 13 determines that the next candidate button 49 is pressed (YES in step S112), then in step S113, the CPU 13 cancels the print setting of stapling at the upper left side, which is the alternative suggestion, and sets punching at the left side, which is the next candidate, as the fixed print setting. Then, the processing returns to step S105. On the other hand, if the CPU 13 determines that the next candidate button 49 is not pressed (NO in step S112), then in step S114, the CPU 13 sets the initially suggested alternative suggestion as the print setting, and the processing returns to step S105 to receive the gesture input.

According to the present exemplary embodiment, since a predetermined print setting is associated with the position and the motion of the gesture, the user can perform the print setting more intuitively and easily.

Since the print setting set based on the gesture is immediately reflected in the preview screen, the user can check the setting result intuitively and graphically.

The print setting table 60 which can support multiple types of paper discharge devices 33 can be registered. Even though the paper discharge device is replaced, it is possible to recognize the gesture according to the capability of the paper discharge device 33. Even though the gesture that cannot be executed by the paper discharge device 33 is present, an alternative setting can be suggested to the user.

Further, in the present exemplary embodiment, the case in which the print setting related to sheet post processing is performed by the gesture has been described, but the image processing apparatus having an interface capable of receiving the gesture can be applied to other function processing.

Therefore, if the image processing apparatus has the interface capable of receiving the gesture, the present invention can be applied to the print setting of, for example, a copy function, a Box print function, and a portable printer function.

Further, the present invention is not limited to the print setting, but the present invention can be applied as an editing method for editing an image to be transmitted when transmitting the image data to an external apparatus.

The above-described exemplary embodiment has been described in connection with the example in which the preview display area 43 is separate from the gesture input area 47, but the preview display area 43 may be configured integrally with the gesture input area 47. Specifically, a touch panel may be disposed on the preview display area 43, and an input from the touch panel may be recognized as the gesture. In this case, setting for image processing can be performed based on the locus of the coordinate information input on a paper displayed on the preview display area 43 and the position of the coordinate information on the paper. For example, when the gesture illustrated in FIG. 4A is recognized at the upper left position of the paper, the CPU 13 recognizes that an instruction for performing stapling at the upper left side of the paper is given.

Further, the present exemplary embodiment has been described in connection with the example in which the image processing apparatus includes the UI unit 20, but the UI unit 20 may be separate from the image processing apparatus. In this case, the UI unit 20 includes an independent CPU and memory to execute the process illustrated in FIG. 5 or 6. The UI unit 20 and the image processing apparatus include a wireless communication unit for performing wireless communication. The UI unit 20 receives image data stored in the HDD 14 of the image processing apparatus via wireless communication, and performs the print setting on the received image data. When a print start instruction is received, the UI unit 20 transmits the image data and the print setting to the image processing apparatus. The image processing apparatus prints the image data received from the UI unit 20 according to the received print setting.

Aspects of the present invention can also be realized by a computer of a system or apparatus (or devices such as a CPU or MPU) that reads out and executes a program recorded on a memory device to perform the functions of the above-described embodiment (s) , and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable storage medium) .

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-296508 filed Dec. 26, 2009, which is hereby incorporated by reference herein in its entirety.

What is claimed is:

1. A printing apparatus for printing an image according to image data, the printing apparatus comprising:
a display unit configured to display an image;
a specifying unit configured to specify a type of a gesture according to a locus of coordinate information input by a user via an operation unit;
a detecting unit configured to detect an area where the gesture is made; and
a setting unit configured to perform print setting for printing image data according to the type of the gesture specified by the specifying unit and the area detected by the detecting unit.

2. The printing apparatus according to claim 1, wherein the area detected by the detecting unit is any one of display areas obtained by dividing a display area of the display unit into a plurality of display areas.

3. The printing apparatus according to claim 1, wherein the setting unit performs first print setting according to a gesture of a first type made on a first area and performs second print setting, different from the first print setting, according to the gesture of the first type made on a second area different from the first area.

4. The printing apparatus according to claim 1, further comprising:
a determining unit configured to determine whether printing according to print setting corresponding to the type of the gesture specified by the specifying unit and the area detected by the detecting unit is executable; and
a suggesting unit configured to suggest alternative print setting to the user when the determining unit determines that printing is not executable.

5. The printing apparatus according to claim 4, wherein the suggesting unit suggests a plurality of alternative print settings to the user, and
wherein the setting unit employs print setting selected by the user from among the plurality of alternative print settings suggested by the suggesting unit.

6. The printing apparatus according to claim 4, further comprising:
an obtaining unit configured to obtain capability information of a post processing apparatus mounted to the printing apparatus,
wherein the determining unit determines, based on the obtained capability information, whether processing of image data according to print setting corresponding to the type of the gesture specified by the specifying unit and the area detected by the detecting unit is executable.

7. A control method for controlling a printing apparatus for printing an image according to image data, the printing apparatus including a display unit, a specifying unit, a detecting unit, and a setting unit, the control method comprising:
via the display unit, displaying an image;
via the specifying unit, specifying a type of a gesture according to a locus of coordinate information input by a user via an operation unit;
via the detecting unit, detecting an area where the gesture is made; and
via the setting unit, performing print setting for printing image data according to the specified type of the gesture and the detected area.

8. A computer-readable storage medium containing computer-executable instructions for controlling a printing apparatus for printing an image according to image data, the medium comprising:
computer-executable instructions that display an image;
computer-executable instructions that specify a type of a gesture according to a locus of coordinate information input by a user via an operation unit;
computer-executable instructions that detect an area where the gesture is made; and
computer-executable instructions that perform print setting for printing image data according to the specified type of the gesture and the detected area.
